(19) United States
(12) Patent Application Publication
(10) Pub. No.: US 2025/0381870 A1
(43) Pub. Date: Dec. 18, 2025

(54) CHARGING ROBOT CONTROL APPARATUS AND METHOD THEREOF

(71) Applicants: HYUNDAI MOTOR COMPANY, Seoul (KR); Kia Corporation, Seoul (KR)

(72) Inventors: Myung Jin KIM, Hwaseong-si (KR); Byung Ho YOON, Hwaseong-si (KR); Ki Hoon NAM, Hwaseong-si (KR); Deuk Jun KIM, Hwaseong-si (KR); Youn LEE, Hwaseong-si (KR); Si Hyun JOO, Hwaseong-si (KR); Jae Pin KIM, Hwaseong-si (KR)

(21) Appl. No.: 18/941,366

(22) Filed: Nov. 8, 2024

(30) Foreign Application Priority Data
Jun. 17, 2024 (KR) 10-2024-0078313

(51) Int. Cl. B60L 53/37; B60L 53/65; B60L 53/66

(52) U.S. Cl. CPC B60L 53/37; B60L 53/65; B60L 53/66

(57) ABSTRACT

A charging robot control apparatus includes a memory storing computer-executable instructions and at least one processor that accesses the memory and executes the instructions. The at least one processor identifies at least one of a vehicle type of a vehicle or a vehicle information number (VIN) of the vehicle, or any combination thereof by means of a vehicle's number, based on recognizing the vehicle's number, controls a charging robot to perform charging of the vehicle, when a parking state of the vehicle is a parking completion state and receiving a charging request from the vehicle, and controls the charging robot to end the charging of the vehicle, based on a target battery amount of the vehicle.

### CROSS-REFERENCE TO RELATED APPLICATION

This application claims the benefit of priority to Korean Patent Application No. 10-2024-0078313, filed in the Korean Intellectual Property Office on Jun. 17, 2024, the entire contents of which are incorporated herein by reference.

### TECHNICAL FIELD

The present disclosure relates to a charging robot control apparatus and a method thereof, and more particularly, relates to technologies for controlling a charging robot configured to charge an electric vehicle.

### BACKGROUND

The demand for electric vehicles is increasing due to growing concerns over environmental pollution caused by vehicle emissions and the rising costs of diesel and gasoline, which serve as fuels for conventional vehicles. With this increase in demand, there is also a corresponding rise in interest in electric vehicle charging robots. Robots are widely used in various fields, driven by advancements in control technology. Examples include surgical robots, housekeeper robots, service robots, aerospace remote robots, and hazardous materials handling robots. Specifically, a service robot may include a charging robot designed for charging electric vehicles.

However, charging robots currently face several challenges, including performing the tasks of recognizing electric vehicles, coupling a charging cable to a charging port to charge the electric vehicle, and decoupling the charging cable coupled to the electric vehicle. These operations may surfer from malfunctions or errors, which present significant drawbacks in the electric vehicle charging process and can negatively impact consumer demand for electric vehicles.

To address these issues, there is a growing need for advanced technology that can effectively control a charging robot and manage malfunctions and errors when they arise during the operation of the charging robot occur.

### SUMMARY

The present disclosure is directed to a charging robot control apparatus for identifying a vehicle type of a vehicle or a VIN of the vehicle by means of a vehicle's number and controlling a charging robot to perform charging of the vehicle to provide a user with an unmanned parking and charging system based on an autonomous parking function and a method thereof.

The present disclosure is also directed to a charging robot control apparatus for controlling a charging robot to end the charging of a vehicle, based on a target battery amount of the vehicle to provide a user with a function in which a driver or the user does not alight from the vehicle to automatically proceed with charging the vehicle and a method thereof.

The present disclosure is also directed to a charging robot control apparatus for identifying an obstacle which interferes with a charging operation of a charging robot, in an operation area including an area where a robot arm included in the charging robot is able to perform charging of the vehicle to increase the safety of the charging robot, while performing an operation of moving the charging robot and an operation of charging the vehicle and a method thereof.

According to an aspect of the present disclosure, a charging robot control apparatus can include a memory storing computer-executable instructions, a communication device that assists in performing communication between the charging robot control apparatus and an external device, and at least one processor that accesses the memory and executes the instructions. The at least one processor can identify at least one of a vehicle type of a vehicle or a vehicle information number (VIN) of the vehicle, or any combination thereof by means of a vehicle's number, based on recognizing the vehicle's number, can control a charging robot to perform charging of the vehicle, when a parking state of the vehicle is a parking completion state and receiving a charging request from the vehicle, and may control the charging robot to end the charging of the vehicle, based on a target battery amount of the vehicle.

In some implementations, the at least one processor can apply the VIN to a vehicle information database to obtain a charging port position of the vehicle, based on identifying the vehicle type and the VIN and can perform communication with the vehicle by means of the VIN to identify the parking state of the vehicle.

In some implementations, the at least one processor can determine whether an autonomous parking state of the vehicle is the same as parking completion, based on that a parking mode of the vehicle is an autonomous parking mode, can determine whether a gear state of the vehicle is a predetermined gear state, based on that the parking mode of the vehicle is a manual parking mode, and can determine the parking state of the vehicle as the parking completion state, based on that the autonomous parking state of the vehicle is the parking completion or the gear state of the vehicle is the predetermined gear state.

In some implementations, the at least one processor can control the charging robot to perform the charging of the vehicle, based on a state of a charging port of the vehicle and a connection state between the vehicle and a charging cable.

In some implementations, the at least one processor can control the charging robot to move to a charging port position of the vehicle, can perform communication with the vehicle by means of the VIN to transmit a command to open the charging port to the vehicle, can receive charging port recognition information identified from a vision controller included in the charging robot, and can control the charging robot to perform the charging of the vehicle, based on the identified charging port recognition information.

In some implementations, the at least one processor can control the charging robot to couple the charging cable to the vehicle, until the connection state between the vehicle and the charging cable is a lock state, and can control the charging robot to perform the charging of the vehicle, based on that the connection state between the vehicle and the charging cable is the lock state.

In some implementations, the at least one processor can control the charging robot to separate a charging cable connected with the vehicle from the vehicle, based on that a connection state between the vehicle and the charging cable is an unlock state, can perform communication with the vehicle by means of the VIN to transmit a command to close a charging port to the vehicle, and can provide a user with a notification including a state in which the vehicle is able to exit, based on the charging cable is separated from the vehicle and the charging port of the vehicle is closed.

In some implementations, the at least one processor can identify an operation area including an area where a robot arm included in the charging robot is able to perform the charging of the vehicle, can perform inspection of a safety function of the charging robot by means of information about the robot arm, and can stop an operation of the charging robot, based on at least one of the operation area or the inspection of the safety function, or any combination thereof.

In some implementations, the at least one processor can identify a link part and a joint part included in the robot arm, based on that the charging robot is performing the charging of the vehicle, can identify at least one of information about the link part, the information being included in the information about the robot arm, or information about being the joint part, the information included in the information about the robot arm, or any combination thereof, and can stop the operation of the charging robot, based on the inspection of the safety function of the charging robot by means of the at least one of the information about the link part of the information about the joint part, or the any combination thereof.

In some implementations, the at least one processor can identify a first position of the joint part from the information about the joint part and may stop the operation of the charging robot, based on a comparison between a difference between the first position and a target position of the joint part, the target position being included in a command for the joint part, and a predetermined reference value.

In some implementations, the at least one processor can identify a second position of the link part from the information about the link part and may stop the operation of the charging robot, based on a comparison between a difference between the second position and a target position of the link part, the target position being included in a command for the link part, and a predetermined reference value.

In some implementations, the at least one processor can identify a driving range of the joint part from the information about the joint part and may stop the operation of the charging robot, based on a comparison between a difference between the driving range of the joint part and a target driving range of the joint part, the target driving range being included in a command for the joint part, and a predetermined reference value.

In some implementations, the at least one processor can identify a driving speed of the joint part from the information about the joint part and may stop the operation of the charging robot, based on a comparison between a difference between the driving speed of the joint part and a target driving speed of the joint part, the target driving speed being included in a command for the joint part, and a predetermined reference value.

In some implementations, the at least one processor can identify first torque applied to the joint part from the information about the joint part and can stop the operation of the charging robot, based on a comparison between the first torque and a maximum torque value allowed to the joint part.

In some implementations, the at least one processor can identify second torque applied to the link part from the information about the link part and can stop the operation of the charging robot, based on a comparison between the second torque and a maximum torque value allowed to the link part.

In some implementations, the at least one processor can output a notification that the operation of the charging robot is stopped, based on that the operation of the charging robot is stopped, through the inspection of the safety function, can provide a user with information about the inspection of the safety function, can determine whether a cause in which the operation is stopped is resolved, after a time point when the information about the inspection of the safety function of the charging robot is provided to the user, and can control the charging robot to perform the charging of the vehicle again, based on the cause in which the operation is stopped is resolved.

In some implementations, the at least one processor can identify an obstacle interfering with a charging operation of the charging robot, in the operation area and can output a notification that the obstacle is identified and stop the operation of the charging robot, based on identifying the obstacle in the operation area.

In some implementations, the at least one processor can obtain signals for detecting an object located in the operation area every predetermined time interval, from sensors included in the charging robot, and can determine that the obstacle is present in the operation area, based on at least one of the signals.

In some implementations, the at least one processor can control the charging robot to disconnect a connection of a charging cable from the vehicle, based on that a battery amount charged in the vehicle is the same as a target battery amount of the vehicle or that a difference between the battery amount charged in the vehicle and the target battery amount of the vehicle is included within a predetermined range, and can transmit a notification that the charging is completed to at least one of the vehicle or a portable terminal of a user of the vehicle, or any combination thereof, based on that the connection of the charging cable is disconnected from the vehicle.

According to another aspect of the present disclosure, a charging robot control method can include identifying at least one of a vehicle type of a vehicle or a vehicle information number (VIN) of the vehicle, or any combination thereof by means of a vehicle's number, based on recognizing the vehicle's number, controlling a charging robot to perform charging of the vehicle, when a parking state of the vehicle is a parking completion state and receiving a charging request from the vehicle, and controlling the charging robot to end the charging of the vehicle, based on a target battery amount of the vehicle.

### BRIEF DESCRIPTION OF THE DRAWINGS

FIG. 1 is a diagram illustrating an example of a charging robot control apparatus.

FIG. 2 is a flowchart for describing an example of a method for controlling a charging robot.

FIG. 3 is a diagram illustrating an example of a system for controlling a charging robot.

FIG. 4 is a diagram illustrating an example of a charging robot.

FIG. 5 is a flowchart for describing an example of a method for controlling a vehicle.

FIG. 6 is a flowchart for describing an example of a method for determining an identified parking state of a vehicle.

FIG. 7 is a flowchart for describing an example of a method for controlling a charging robot to perform charging through recognition of a charging port.

FIG. 8 is a flowchart for describing an example of a method for controlling a charging robot to stop charging based on a state of a charging port.

FIG. 9 is a flowchart for describing an example of a method for performing inspection of a safety function of a charging robot.

FIG. 10 is a flowchart for describing an example of a method for controlling a charging robot depending on identifying an obstacle.

FIG. 11 is a flowchart for describing an example of a method for controlling a charging robot depending on stopping an operation of a charging robot.

FIGS. 12A and 12B are diagrams illustrating an example of a method for determining an operation area.

FIG. 13 is a diagram illustrating an example of a computing system associated with a charging robot control apparatus or a charging robot control method.

### DETAILED DESCRIPTION

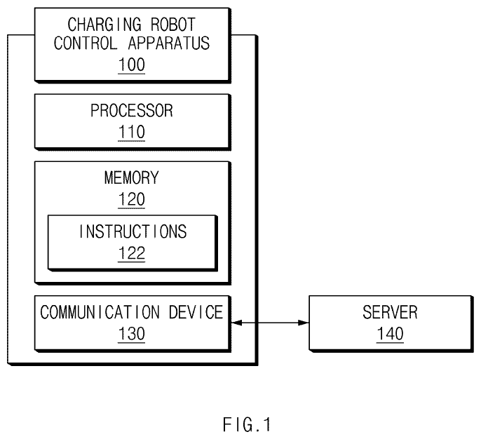

Hereinafter, the present disclosure will be described in detail with reference to FIGS. 1 to 13.

FIG. 1 is a diagram illustrating an example of a charging robot control apparatus.

A charging robot control apparatus 100 can include a processor 110, a memory 120 including instructions 122, and a communication device 130.

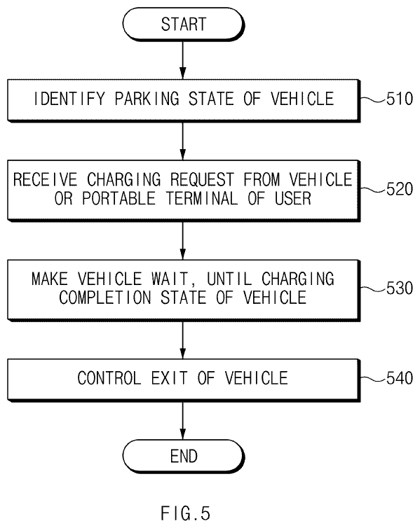

The charging robot control apparatus 100 can refer to an apparatus for controlling a charging robot configured to charge a vehicle. For example, the charging robot control apparatus 100 can determine a parking state of the vehicle, identify a charging port of the vehicle, couple a charging cable to the identified charging port to control the charging robot to perform charging of the vehicle, identify an obstacle and perform an inspection of the chagrining robot's safety function during the vehicle charging process, stop an operation of the charging robot, and provide a user with information regarding the safety inspection to address the cause of the operation stoppage. For example, the charging robot control apparatus 100 can control the charging robot through the above-mentioned operations to provide the user with a service, such that the user does not alight from the vehicle to automatically proceed with the charging of the vehicle. Hereinafter, a detailed description of the operation performed by the charging robot control apparatus 100 to provide the user with the service will be given with reference to FIGS. 5 to 11.

The processor 110 can execute software and control at least one other component (e.g., a hardware or software component) connected with the processor 110. In addition or alternatively, the processor 110 can perform a variety of data processing or calculation. For example, the processor 110 can store, in the memory 120, at least one of a vehicle type of the vehicle, a vehicle information number (VIN) of the vehicle, a charging port position of the vehicle, or charging port recognition information.

In some implementations, the processor 110 can perform all operations performed by the charging robot control apparatus 100. Therefore, for convenience of description in the specification, the operation performed by the charging robot control apparatus 100 is mainly described as an operation performed by the processor 110. Furthermore, for convenience of description in the specification, the processor 110 is mainly described as, but not limited to, one processor. For example, the charging robot control apparatus 100 can include at least one processor. Each of the at least one processor can perform all operations associated with the charging robot control apparatus 100.

The memory 120 can temporarily and/or permanently store various pieces of data and/or information required to perform an operation for controlling the charging robot. For example, the memory 120 can store the at least one of the vehicle type of the vehicle, the VIN of the vehicle, the charging port position of the vehicle, or the charging port recognition information.

The communication device 130 can perform communication between the charging robot control apparatus 100 and a server 140. For example, the communication device 130 can include one or more components for performing communication between the charging robot control apparatus 100 and the server 140. For example, the communication device 130 can include a short range wireless communication unit, a microphone, or the like. By way of further example, a short range communication technology may be, but is not limited to, a wireless LAN (WI-FI), Bluetooth, ZigBee, Wi-Fi Direct (WFD), ultra-wideband (UWB), infrared data association (IrDA), Bluetooth low energy (BLE), near field communication (NFC), or the like.

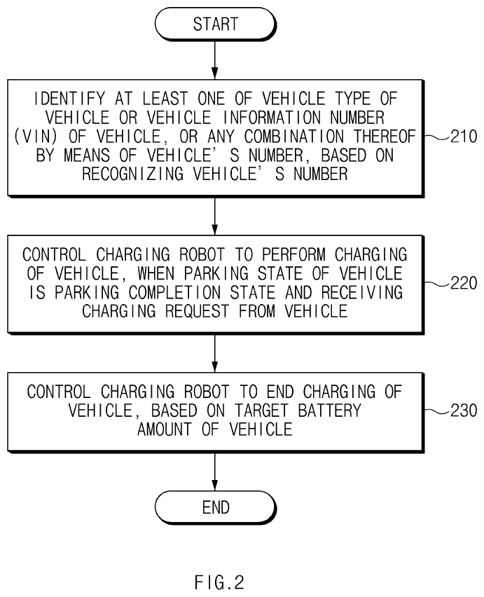

FIG. 2 is a flowchart for describing an example of a method for controlling a charging robot.

In operation 210, a charging robot control apparatus (e.g., a charging robot control apparatus 100 of FIG. 1) can identify at least one of a vehicle type of a vehicle or a VIN of the vehicle, or any combination thereof, based on recognizing a vehicle's number. For example, the charging robot control apparatus can identify the at least one of the vehicle type of the vehicle or the VIN of the vehicle, or the any combination thereof to perform charging operations of the vehicle.

In operation 220, the charging robot control apparatus can control the charging robot to perform charging of the vehicle, when a parking state of the vehicle is a parking completion state and a charging request is received from the vehicle. For example, the parking state of the vehicle can include a parking completion state and a parking incompletion state. When the parking state of the vehicle is the parking completion state, the charging robot control apparatus can determine that the vehicle is waiting for charging. Thereafter, the charging robot control apparatus can receive a charging request from the vehicle. In some implementations, the charging robot control apparatus can receive a charging request through communication with the vehicle, rather than directly receiving the charging request from the user.

In operation 230, the charging robot control apparatus can control the charging robot to end the charging of the vehicle, based on a target battery amount of the vehicle. For example, the charging robot control apparatus can receive the target battery amount from the vehicle. The target battery amount can be determined based on the user or a state of the battery of the vehicle. The charging robot control apparatus can determine charging completion of the vehicle through a comparison between a current battery amount of the vehicle and the target battery amount. When the charging of the vehicle is completed, the charging robot control apparatus can control the charging robot to end the charging of the vehicle.

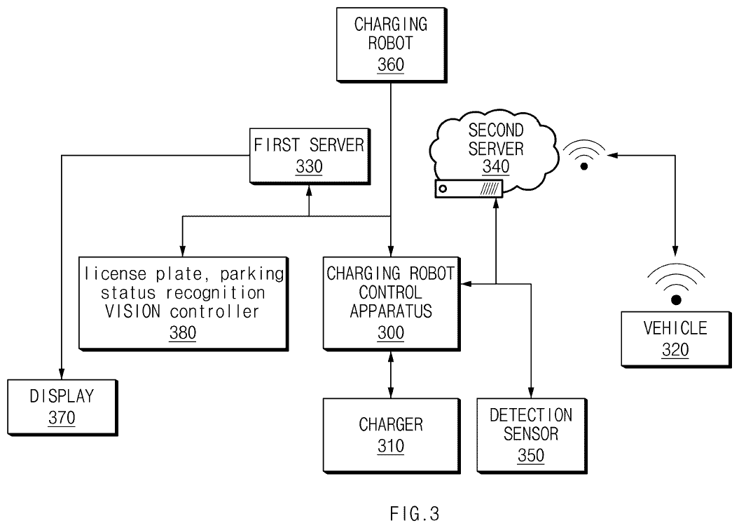

FIG. 3 is a diagram illustrating an example of a system for controlling a charging robot.

A charging robot control apparatus 300 can perform communication with a charger 310, a first server 330, or a second server 340 to control a charging robot 360 which charges a vehicle 320. For reference, for convenience of description in the specification, the vehicle 320 will be described as including an electric vehicle.

For example, the first server 330 can be a server which is in charge of the overall operation of an automatic charging system of the vehicle 320, which provides an interface with a customer and a scenario of the charging robot 360. The second server 340 can perform communication with the vehicle 320 to deliver information of the vehicle 320 to the charging robot control apparatus 300.

The charger 310 can refer to indicate a charger of the vehicle 320 and include an ultra-fast vehicle charger. The charging robot control apparatus 300 can transmit an operating state associated with an operation of the charging robot 360 and a parking guide for a user to the first server 330. Thereafter, the first server 330 can output the operating state associated with the operation of the charging robot 360 and the parking guide for the user on a display 370.

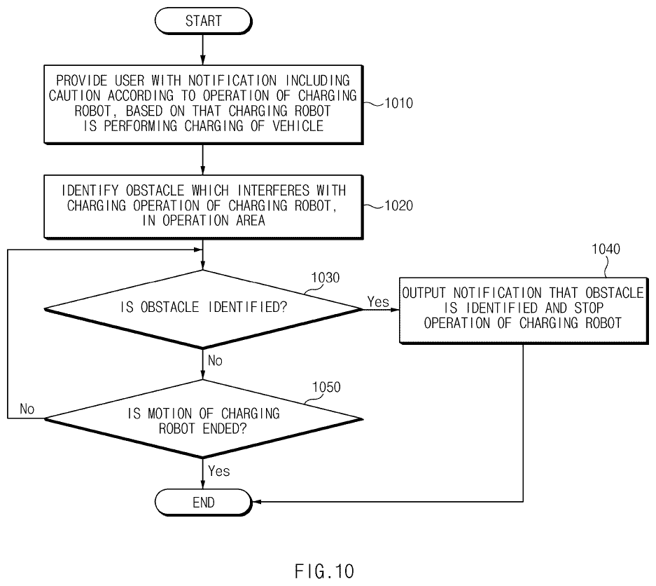

The charging robot control apparatus 300 can obtain signals every predetermined time interval from detection sensors 350 to identify an obstacle. A detailed description associated with it will be given below with reference to FIG. 10.

The license plate, parking status recognition VISION controller 380 can refer to a VISION module controller configured to recognize a license plate of the vehicle 320, and a parking status. The charging robot control apparatus 300 can determine whether the vehicle 320 is parked based on the license plate, the parking status of the vehicle 320 recognized by the parking status recognition VISION controller 380, and the parking status of the vehicle 320.

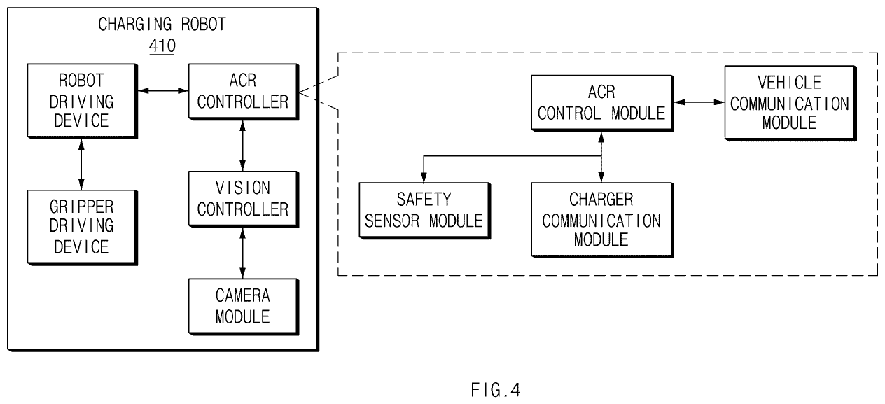

FIG. 4 is a diagram illustrating an example of a charging robot.

A charging robot control apparatus (e.g., a charging robot control apparatus 100 of FIG. 1) can control a charging robot 410. The charging robot 410 controlled by the charging robot control apparatus can include a robot driving device, a gripper driving device, a vision controller, a camera module, and an autonomous case-handling robot (ACR) controller. In some implementations, the robot driving device can drive a motor included in the charging robot 410. The gripper driving device can drive a gripper for allowing the charging robot 410 to grasp a charging cable. The vision controller can recognize at least one of a charging port, a vehicle's number, or a parking state of a vehicle. The camera module can refer to a camera module which is installed at an end of the charging robot 410 and configured to recognize the charging port. The ACR controller can perform control of the charging robot 410, control of a system interworking with the charging robot 410, and control for monitoring an operation of the charging robot 410. The plurality of components can be controlled by a command of the charging robot control apparatus. Thus, for convenience of description in the specification, it is described that each of the plurality of components included in the charging robot 410 is able to be controlled by a command of the charging robot control apparatus.

For example, the ACR controller can include an ACR control module, a vehicle communication module, a safety sensor module, and a charger communication module. In some implementations, the ACR control module can be a module for controlling motion of the charging robot 410 which performs charging of the vehicle and a system associated with the motion. The safety sensor module can be a sensor module for sensing an obstacle which accesses the vicinity of the charging robot 410. The vehicle communication module can refer to a module for performing wireless communication with the vehicle to control the charging port and check a state of charge. The charger communication module can refer to a communication module which is connected with an ultra-fast charger to determine a state of the charger.

FIG. 5 is a flowchart for describing an example of a method for controlling a vehicle.

In operation 510, a charging robot control apparatus (e.g., a charging robot control apparatus 100 of FIG. 1) can identify a parking state of a vehicle. For example, a user may park the vehicle in a manual or automatic scheme. In some implementations, the parking of the vehicle in the manual scheme can refer to parking under control of the user. In some implementations, the parking of the vehicle in the automatic scheme can refer to parking under control of the vehicle according to autonomous parking.

In operation 520, the charging robot control apparatus can receive a charging request from the vehicle or a portable terminal of the user. In some implementations, the charging robot control apparatus can directly receive a charging request from the vehicle, the parking of which is completed.

In operation 530, the charging robot control apparatus can make the vehicle wait, until a charging completion state of the vehicle. For example, the charging robot control apparatus can provide the user with a notification that movement is prohibited according to a state of charge by displaying information to thereby make the vehicle to wait.

In operation 540, the charging robot control apparatus can control exit of the vehicle. For example, the charging robot control apparatus can provide the user with a notification that movement is possible according to charging completion by displaying corresponding information to thereby control the exit of the vehicle. Herein, the user may make the vehicle to exit in a manual or automatic scheme.

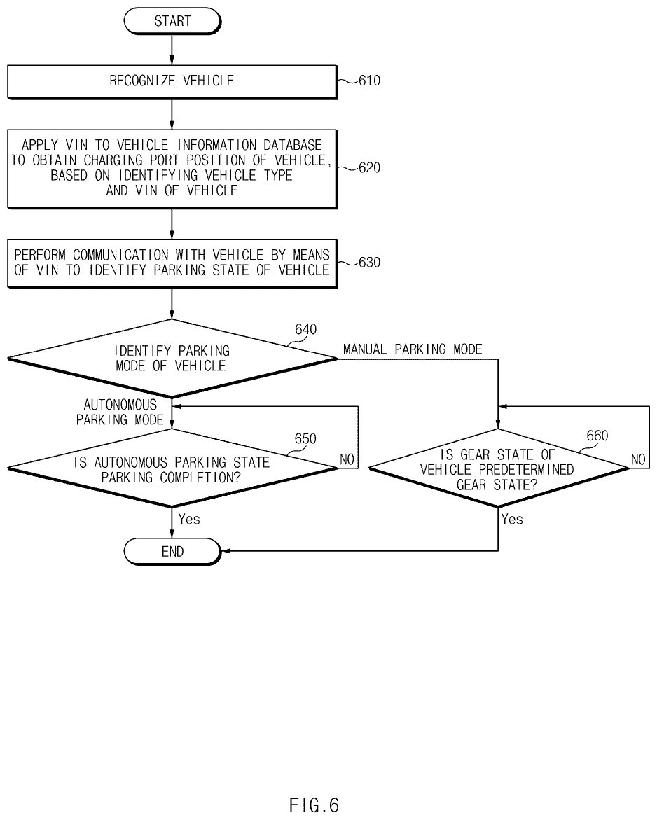

FIG. 6 is a flowchart for describing an example of a method for determining an identified parking state of a vehicle.

In operation 610, a charging robot control apparatus (e.g., a charging robot control apparatus 100 of FIG. 1) can recognize a vehicle. For example, the charging robot control apparatus can recognize a vehicle's number and a parking state of the vehicle. The charging robot control apparatus can start charging the vehicle, based on that the parking state of the vehicle indicates that the parking of the vehicle is completed.

In operation 620, the charging robot control apparatus can apply a VIN to a vehicle information database to obtain a charging port position of the vehicle, based on a vehicle type and the VIN being identified. The charging robot control apparatus can obtain the charging port position of the vehicle from the vehicle information database, thus controlling a charging robot to couple a charging cable to the charging port position.

In operation 630, the charging robot control apparatus can perform communication with the vehicle based on the VIN to identify the parking state of the vehicle.

In operation 640, the charging robot control apparatus can identify a parking mode of the vehicle to identify the parking state of the vehicle. For example, when the parking mode of the vehicle is an autonomous parking mode, in operation 650, the charging robot control apparatus can determine whether an autonomous parking state of the vehicle is the same as parking completion. When the autonomous parking state of the vehicle is not the parking completion, the charging robot control apparatus can repeatedly identify and determine the parking state of the vehicle, until the autonomous parking state is the parking completion. The charging robot control apparatus can obtain pieces of information associated with a controller area network database (CAN DB) of the vehicle, through the communication with the vehicle. The charging robot control apparatus can identify the autonomous parking state, based on the obtained pieces of information associated with the CAN DB.

In operation 660, the charging robot control apparatus can determine whether the gear state of the vehicle is a predetermined gear (e.g., parking gear) state, based on that the parking mode of the vehicle is a manual parking mode. When the gear state of the vehicle is not the predetermined gear state, the charging robot control apparatus can repeatedly identify and determine the parking state of the vehicle, until the gear state of the vehicle is the predetermined gear state. The charging robot control apparatus can identify the gear state of the vehicle, based on the obtained pieces of information associated with the CAN DB.

The charging robot control apparatus can determine the parking state of the vehicle as a parking completion state, based on that the autonomous parking state of the vehicle is the parking completion or the gear state of the vehicle is the predetermined gear state. As a result, the charging robot control apparatus can control the charging robot to start charging the vehicle.

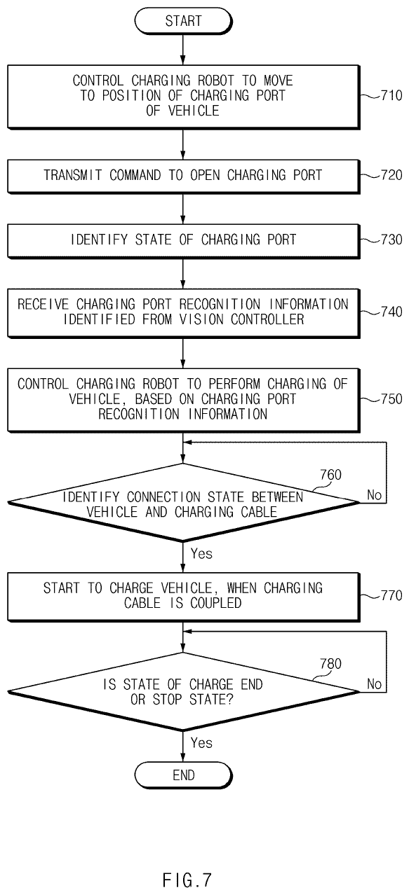

FIG. 7 is a flowchart for describing an example of a method for controlling a charging robot to perform charging through recognition of a charging port.

In operation 710, a charging robot control apparatus (e.g., a charging robot control apparatus 100 of FIG. 1) can control a charging robot to move to a position of a charging port of a vehicle. For example, the charging robot control apparatus can control the charging robot to perform charging of the vehicle, based on a state of the charging port of the vehicle and a connection state between the vehicle and a charging cable.

In operation 720, the charging robot control apparatus can transmit a command to open the charging port to the vehicle. In some implementations, the charging robot control apparatus can perform communication with the vehicle using a VIN to transmit the command to open the charging port to the vehicle.

In operation 730, the charging robot control apparatus can identify the state of the charging port. For example, in operation 740, the charging robot control apparatus can receive charging port recognition information identified from a vision controller included in the charging robot to identify the state of the charging port.

In operation 750, the charging robot control apparatus can control the charging robot to perform charging of the vehicle, based on the identified charging port recognition information. In some implementations, in operation 760, the charging robot control apparatus can identify the connection state between the vehicle and the charging cable, based on a determination to control the charging robot. For example, the charging robot control apparatus can identify whether the connection state between the vehicle and the charging cable is a lock state. By way of further example, the charging robot control apparatus can control the charging robot to couple the charging cable to the vehicle, until the connection state between the vehicle and the charging cable is the lock state.

The charging robot control apparatus can obtain pieces of information associated with a CAN DB of the vehicle, through the communication with the vehicle. The charging robot control apparatus can identify the connection state between the vehicle and the charging cable, based on the obtained pieces of information associated with the CAN DB. Thereafter, when the connection state between the vehicle and the charging cable is the lock state, the charging robot control apparatus can perform the following operations.

In operation 770, the charging robot control apparatus can start charging the vehicle, when the charging cable is coupled to the vehicle. For example, the charging robot control apparatus can control the charging robot to perform charging of the vehicle, based on that the connection state between the vehicle and the charging cable is the lock state.

In operation 780, the charging robot control apparatus can determine whether the state of charge is an end or stop state. For example, when the state of charge is the end or stop state, the charging robot control apparatus can end the control of the charging robot.

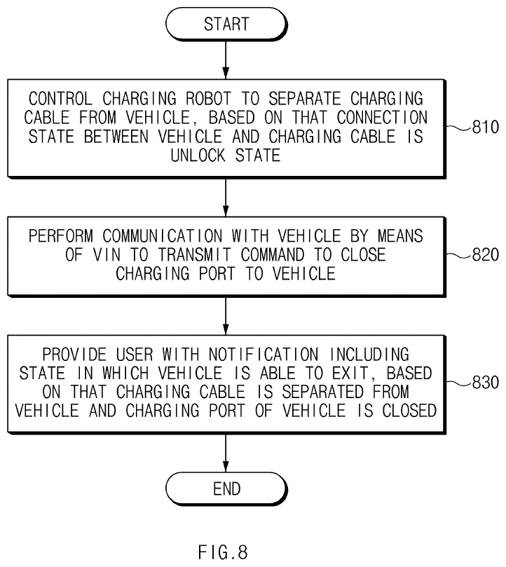

FIG. 8 is a flowchart for describing an example of a method for controlling a charging robot to stop charging based on a state of a charging port.

In operation 810, a charging robot control apparatus (e.g., a charging robot control apparatus 100 of FIG. 1) can control a charging robot to disconnect a charging cable connected from a vehicle from the vehicle, based on that a connection state between the vehicle and the charging cable is an unlock state. The charging robot control apparatus can disconnect the charging cable from the vehicle to end charging of the vehicle.

The charging robot control apparatus can control the charging robot to disconnect the connection of the charging cable from the vehicle, based on that a battery amount charged in the vehicle is the same as a target battery amount of the vehicle or that a difference between the battery amount charged in the vehicle and the target battery amount of the vehicle is within a predetermined range. For example, the charging robot control apparatus can obtain pieces of information associated with a CAN DB of the vehicle, through communication with the vehicle. The charging robot control apparatus can compare the battery amount charged in the vehicle with the target battery amount of the vehicle, based on the obtained pieces of information associated with the CAN DB.

In operation 820, the charging robot control apparatus can perform communication with the vehicle using a VIN to transmit a command to close a charging port to the vehicle.

In operation 830, the charging robot control apparatus can provide a user with a notification including a state in which the vehicle is able to exit, based on that the charging cable is disconnected from the vehicle and the charging port of the vehicle is closed. For example, the charging robot control apparatus can output the notification including the state in which the vehicle is able to exit on a display, thus providing the user with the notification. Furthermore, the charging robot control apparatus can transmit a notification of charging completion to at least one of the vehicle or a portable terminal of the user of the vehicle, based on that the charging cable is disconnected or separated from the vehicle.

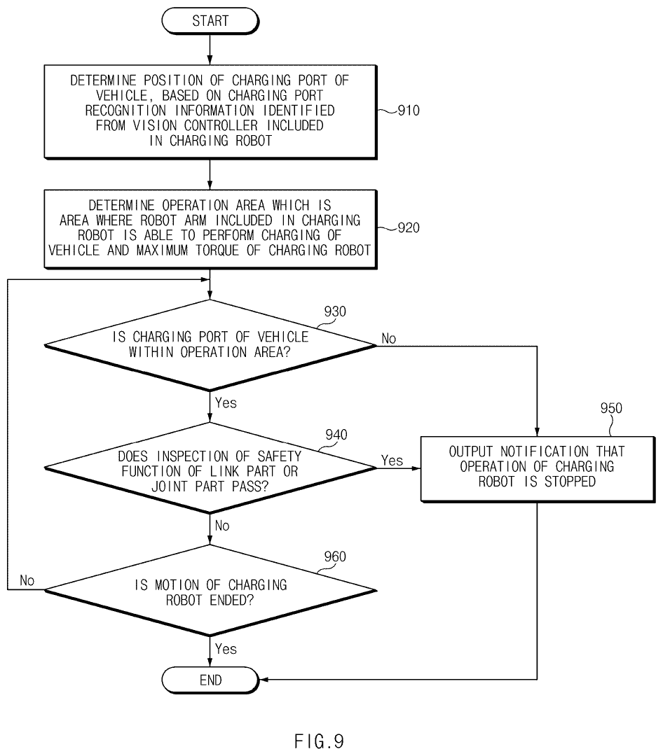

FIG. 9 is a flowchart for describing an example of a method for performing inspection of a safety function of a charging robot.

In operation 910, a charging robot control apparatus (e.g., a charging robot control apparatus 100 of FIG. 1) can determine a position of a charging port of a vehicle, based on charging port recognition information identified from a vision controller included in a charging robot. Thereafter, the charging robot control apparatus can identify an operation area including an area where a robot arm included in the charging robot is able to perform charging of the vehicle.

In operation 920, the charging robot control apparatus can perform inspection of a safety function of the charging robot using information regarding the robot arm of the charging robot. The inspection of the safety function can include inspection about a function of the robot arm included in the charging robot. For example, the inspection of the safety function can be performed by inspecting torque and a position of each of a link part (e.g., including an end of the robot arm) and a joint part, which are included in the robot arm.

In operations 930 and 940, the charging robot control apparatus can stop the operation of the charging robot, based on at least one of the operation area or the inspection of the safety function. For example, in operation 930, the charging robot control apparatus can determine whether the charging port of the vehicle is within the operation area. When the charging port is not within the operation area, in operation 950, the charging robot control apparatus can output a notification that the operation of the charging robot is stopped. In some implementations, in operation 940, the charging robot control apparatus can determine whether the inspection of the safety function of the link part or the joint part passes. When the inspection of the safety function of the link part or the joint part does not pass, in operation 950, the charging robot control apparatus can output the notification that the operation of the charging robot is stopped.

In conjunction with the inspection of the safety function, the charging robot control apparatus can perform the following operations. The charging robot control apparatus can identify the link part and the joint part included in the robot arm, based on that the charging robot is performing charging of the vehicle. The charging robot control apparatus can identify at least one of information about the link part, which is included in information about the robot arm, or information about the joint part, which is included in the information about the robot arm. Thereafter, the charging robot control apparatus can stop the operation of the charging robot, based on the inspection of the safety function using the at least one of the information about the link part or the information about the joint part. The inspection of the safety function can include examples below.

In some implementations, the charging robot control apparatus can identify a first position of the joint part from the information about the joint part. The charging robot control apparatus can stop the operation of the charging robot, based on a comparison between a difference between the first position and a target position of the joint part, which is included in a command for the joint part, with a predetermined reference value. For example, when the difference between the first position and the target position is greater than the predetermined reference value, the charging robot control apparatus can stop the operation of the charging robot.

In some implementations, the charging robot control apparatus can identify a second position of the joint part from the information about the link part. The charging robot control apparatus can stop the operation of the charging robot, based on a comparison between a difference between the second position and a target position of the link part, which is included in a command for the link part, with the predetermined reference value. For example, when the difference between the second position and the target position is greater than the predetermined reference value, the charging robot control apparatus can stop the operation of the charging robot.

In some implementations, the charging robot control apparatus can identify a driving range of the joint part from the information about the joint part. The charging robot control apparatus can stop the operation of the charging robot, based on a comparison between a difference between the driving range of the joint part and a target driving range of the joint part, which is included in a command for the joint part, and the predetermined reference value. For example, when the difference between the driving range of the joint part and the target driving range is greater than the predetermined reference value, the charging robot control apparatus can stop the operation of the charging robot.

In some implementations, the charging robot control apparatus can identify a driving speed of the joint part from the information about the joint part. The charging robot control apparatus can stop the operation of the charging robot, based on a comparison between a difference between the driving speed of the joint part and a target driving speed of the joint part, which is included in a command for the joint part, and the predetermined reference value. For example, when the difference between the driving speed of the joint part and the target driving speed is greater than the predetermined reference value, the charging robot control apparatus can stop the operation of the charging robot.

In some implementations, the charging robot control apparatus can identify first torque applied to the joint part from the information about the joint part. The charging robot control apparatus can stop the operation of the charging robot, based on a comparison between the first torque and a maximum torque value allowed to the joint part. For example, when the first torque is greater than the maximum torque value, the charging robot control apparatus can stop the operation of the charging robot.

In some implementations, the charging robot control apparatus can identify second torque applied to the link part from the information about the link part. The charging robot control apparatus can stop the operation of the charging robot, based on a comparison between the second torque and a maximum torque value allowed to the link part. For example, when the second torque is greater than the maximum torque value, the charging robot control apparatus can stop the operation of the charging robot. The maximum torque value can refer to a value determined at a time point when the charging robot is produced or can include a value input from a user.

In operation 960, the charging robot control apparatus can check and determine whether motion of the charging robot has ended. For example, when it is checked that the motion of the charging robot has ended, the charging robot control apparatus can control the charging robot to end the charging of the vehicle.

FIG. 10 is a flowchart for describing an example of a method for controlling a charging robot depending on identifying an obstacle.

In operation 1010, a charging robot control apparatus (e.g., a charging robot control apparatus 100 of FIG. 1) can provide a user with a notification including caution according to an operation of a charging robot, based on that the charging robot is performing charging of a vehicle.

In operation 1020, the charging robot control apparatus can identify an obstacle which interferes with the charging operation of the charging robot, in an operation area. For example, the charging robot control apparatus can obtain signals for detecting an object located in the operation area every predetermined time interval, from sensors included in the charging robot. The charging robot control apparatus can determine that the obstacle is present within the operation area, based on at least one of the signals. For example, the charging robot control apparatus can determine that the obstacle is present within the operation area, based on at least one of the signals being an off signal.

In operation 1030, the charging robot control apparatus can determine whether the obstacle is identified. In operation 1040, the charging robot control apparatus can output a notification that the obstacle is identified and stop the operation of the charging robot, based on the obstacle in the operation area being identified. In some implementations, in operation 1050, the charging robot control apparatus can check and determine whether motion of the charging robot has ended, based on the obstacle not being identified in the operation area. For example, when it is checked that the motion of the charging robot has ended, the charging robot control apparatus can control the charging robot to end the charging of the vehicle.

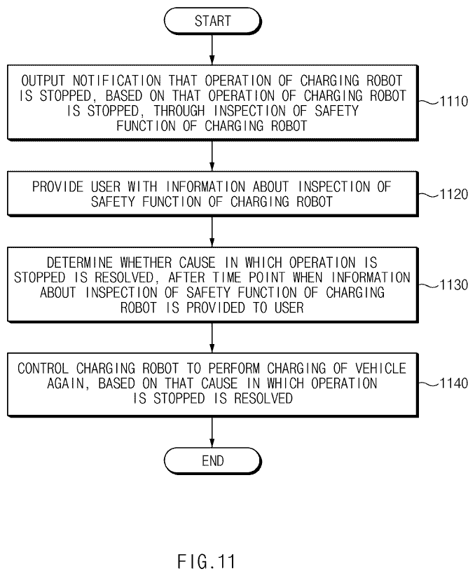

FIG. 11 is a flowchart for describing an example of a method for controlling a charging robot depending on stopping an operation of a charging robot.

In operation 1110, a charging robot control apparatus (e.g., a charging robot control apparatus 100 of FIG. 1) can output a notification that an operation of a charging robot has stopped, based on that the operation of the charging robot has stopped, through inspection of a safety function.

In operation 1120, the charging robot control apparatus can provide a user with information about the inspection of the safety function. For example, when the operation of the charging robot has stopped, the charging robot control apparatus can provide the user with the information about the inspection of the safety function to address it.

In operation 1130, the charging robot control apparatus can determine whether the cause in which the operation has stopped is resolved, after a time point when the information about the inspection of the safety function of the charging robot is provided to the user. For example, the charging robot control apparatus can identify at least one of whether a charging port of a vehicle is within an operation area, whether an obstacle is not identified in the operation area, or whether an error of the charging robot according to the inspection of the safety function of the charging robot (e.g., when the position or torque of a link part is greater than a target position or maximum torque) is resolved.

In operation 1140, the charging robot control apparatus can control the charging robot to perform charging of the vehicle again, based on that the cause in which the operation has stopped is resolved.

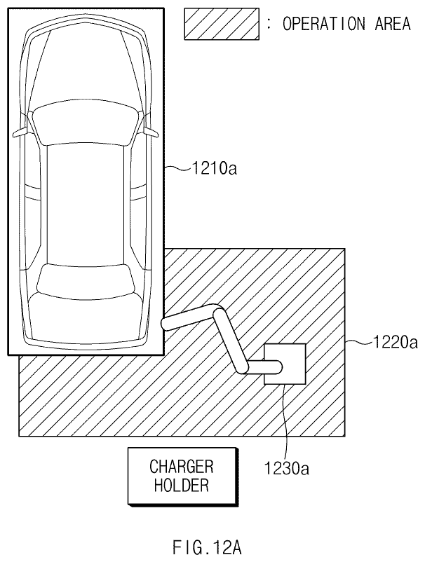

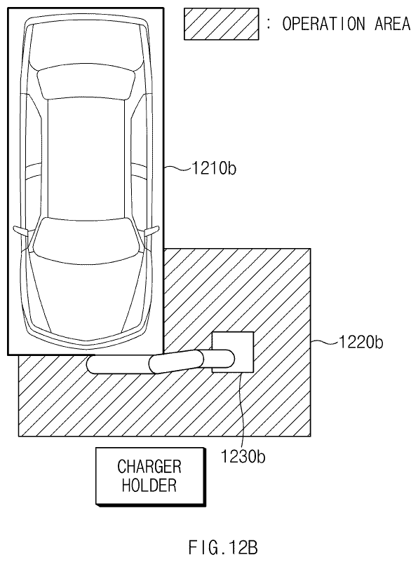

FIGS. 12A and 12B are diagrams for describing an example of a method for determining an operation area.

A charging robot control apparatus (e.g., a charging robot control apparatus 100 of FIG. 1) can identify and determine an operation area 1220a or 1220b including an area where a robot arm included in a charging robot 1230a or 1230b is capable of performing charging of a vehicle 1210a or 1210b.

For example, the vehicle 1210a or 1210b can be located in a state of parking in which the front of the vehicle 1210a or 1210b and the charging robot 1230a or 1230b are adjacent to each other or parking in which the rear of the vehicle 1210a or 1210b and the charging robot 1230a or 1230b are adjacent to each other, in an area including a predetermined distance from the charging robot 1230a or 1230b. When the vehicle 1210a or 1210b is parked, the charging robot control apparatus can determine a space and area where the robot arm included in the charging robot 1230a or 1230b is capable of coupling a charging cable to a charging port of the vehicle 1210a or 1210b as the operation area 1220a or 1220b. Therefore, the operation area 1220a or 1220b can include an area where the charging robot 1230a or 1230b is capable of performing an operation associated with charging of the vehicle 1210a or 1210b at the same time as including an area where the robot arm is capable of performing charging of the vehicle 1210a or 1210b.

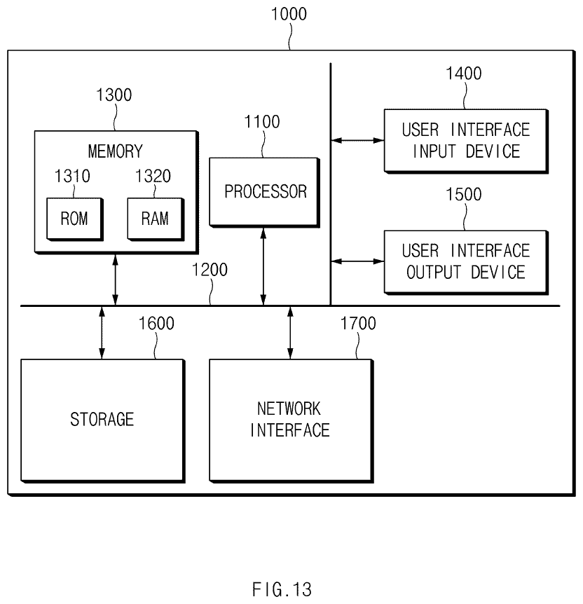

FIG. 13 is a diagram illustrating an example of a computing system associated l with a charging robot control apparatus or a charging robot control method.

Referring to FIG. 13, a computing system 1000 about the charging robot control apparatus or the charging robot control method can include at least one processor 1100, a memory 1300, a user interface input device 1400, a user interface output device 1500, storage 1600, and a network interface 1700, which are connected with each other via a bus 1200.

The processor 1100 can be a central processing unit (CPU) or a semiconductor device that processes instructions stored in the memory 1300 and/or the storage 1600. The memory 1300 and the storage 1600 can include various types of volatile or non-volatile storage media. For example, the memory 1300 can include a ROM (Read Only Memory) 1310 and a RAM (Random Access Memory) 1320.

Accordingly, the operations of the method or algorithm described in connection with the implementations disclosed in the specification may be directly implemented with a hardware module, a software module, or a combination of the hardware module and the software module, which is executed by the processor 1100. The software module can reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium can be coupled to the processor 1100. The processor 1100 can read out information from the storage medium and can write information in the storage medium. Alternatively, the storage medium can be integrated with the processor 1100. The processor and the storage medium may reside in an application specific integrated circuit (ASIC). The ASIC can reside within a user terminal. In some implementations, the processor and the storage medium can reside in the user terminal as separate components.

The above-described implementations can be implemented with hardware components, software components, and/or a combination of hardware components and software components. For example, the devices, methods, and components can be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit can perform an operating system (OS) or a software application running on the OS. Further, the processing unit can access, store, manipulate, process and generate data in response to execution of software. It will be understood by those skilled in the art that although a single processing unit can be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software can include computer programs, codes, instructions or one or more combinations thereof and may configure a processing unit to operate in a desired manner or can independently or collectively instruct the processing unit. Software and/or data may be permanently or temporarily implemented in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one computer-readable storage media.

The methods can be implemented in the form of program instructions which may be executed through various computer means and may be recorded in computer-readable media. The computer-readable media can include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The above-described hardware devices can be configured to act as one or a plurality of software modules to perform the operations of the implementations, or vice versa.

According implementations of features of the present disclosure discussed above, the charging robot control apparatus can identify a vehicle type of a vehicle or a VIN of the vehicle using a vehicle's number and control a charging robot to perform charging of the vehicle, thus providing a user with an unmanned parking and charging system based on an autonomous parking function.

According to implementations of features described above, the charging robot control apparatus can control the charging robot to end the charging of the vehicle, based on a target battery amount of the vehicle, thus providing the user with a function in which a driver or the user does not alight from the vehicle to automatically proceed with charging the vehicle.

According to implementations of features described above, the charging robot control apparatus can identify an obstacle which interferes with a charging operation of the charging robot, in an operation area including an area where a robot arm included in the charging robot is able to perform charging of the vehicle, thus increasing the safety of the charging robot, while performing an operation of moving the charging robot and an operation of charging the vehicle.

What is claimed is:

1. A charging robot control apparatus, comprising:
a memory storing computer-executable instructions; and
at least one processor configured to access the memory and execute the instructions to perform operations comprising:
identifying, based on a number associated with a vehicle being recognized, at least one of a vehicle type of the vehicle or a vehicle information number (VIN) of the vehicle;
controlling, based on a parking state of the vehicle being a parking completion state and a charging request being received from the vehicle, a charging robot to charge the vehicle; and
controlling, based on a target battery amount of the vehicle, the charging robot to stop charging the vehicle.

2. The charging robot control apparatus of claim 1, wherein the operations comprise:
applying, based on the VIN being identified, the VIN to a vehicle information database to obtain a charging port position of the vehicle, and
transmitting, based on the VIN, a request to the vehicle to identify the parking state of the vehicle.

3. The charging robot control apparatus of claim 2, wherein the operations comprise:
determining, based on a parking mode of the vehicle being an autonomous parking mode, whether an autonomous parking state of the vehicle indicates parking completion,
determining, based on the parking mode of the vehicle being a manual parking mode, whether a gear state of the vehicle is a predetermined gear state, and
determining, based on the autonomous parking state of the vehicle indicating parking completion or the gear state of the vehicle being the predetermined gear state, the parking state of the vehicle as the parking completion state.

4. The charging robot control apparatus of claim 1, wherein the operations comprise:
controlling, based on a state of a charging port of the vehicle and a connection state between the vehicle and a charging cable, the charging robot to charge the vehicle.

5. The charging robot control apparatus of claim 4, wherein the operations comprise:
controlling the charging robot to move to a charging port position of the vehicle,
transmitting, based on the VIN, a command to open the charging port to the vehicle,
receiving charging port recognition information identified from a vision controller included in the charging robot, and
controlling, based on the identified charging port recognition information, the charging robot to charge the vehicle.

6. The charging robot control apparatus of claim 4, wherein the operations comprise:
controlling the charging robot to couple the charging cable to the vehicle, until the connection state between the vehicle and the charging cable is a lock state, and
controlling, based on the connection state between the vehicle and the charging cable being the lock state, the charging robot to charge the vehicle.

7. The charging robot control apparatus of claim 1, wherein the operations comprise:
controlling, based on a connection state between the vehicle and a charging cable being an unlock state, the charging robot to disconnect the charging cable from the vehicle,
transmitting, based on the VIN, a command to close a charging port to the vehicle, and
providing a notification indicating that the vehicle is ready to exit, based on the charging cable being separated from the vehicle and the charging port of the vehicle being closed.

8. The charging robot control apparatus of claim 1, wherein the operations comprise:
identifying an operation area including an area where a robot arm included in the charging robot is capable of charging the vehicle,
performing inspection of a safety function of the charging robot based on information regarding the robot arm, and
stopping an operation of the charging robot, based on at least one of the operation area or the inspection of the safety function.

9. The charging robot control apparatus of claim 8, wherein the operations comprise:
identifying, the charging robot performing charging of the vehicle, a link part and a joint part included in the robot arm,
identifying at least one of (i) information regarding the link part that is included in the information regarding the robot arm or (ii) information regarding the joint part that is included in the information regarding the robot arm, and
stopping the operation of the charging robot, based on the inspection of the safety function of the charging robot using the at least one of the information regarding the link part or the information regarding the joint part.

10. The charging robot control apparatus of claim 9, wherein the operations comprise:
identifying a first position of the joint part from the information regarding the joint part, and
stopping the operation of the charging robot, based on a comparison between a difference between the first position and a target position of the joint part, the target position being included in a command for the joint part, and a predetermined reference value.

11. The charging robot control apparatus of claim 9, wherein the operations comprise:
identifying a second position of the link part from the information regarding the link part, and
stopping the operation of the charging robot, based on a comparison between a difference between the second position and a target position of the link part, the target position being included in a command for the link part, and a predetermined reference value.

12. The charging robot control apparatus of claim 9, wherein the operations comprise:
identifying a driving range of the joint part from the information regarding the joint part, and
stopping the operation of the charging robot, based on a comparison between a difference between the driving range of the joint part and a target driving range of the joint part, the target driving range being included in a command for the joint part, and a predetermined reference value.

13. The charging robot control apparatus of claim 9, wherein the operations comprise:
identifying a driving speed of the joint part from the information regarding the joint part, and
stopping the operation of the charging robot, based on a comparison between a difference between the driving speed of the joint part and a target driving speed of the joint part, the target driving speed being included in a command for the joint part, and a predetermined reference value.

14. The charging robot control apparatus of claim 9, wherein the operations comprise:
identifying a first torque applied to the joint part from the information regarding the joint part, and
stopping the operation of the charging robot, based on a comparison between the first torque and a maximum torque value allowed to the joint part.

15. The charging robot control apparatus of claim 9, wherein the operations comprise:
Identifying a second torque applied to the link part from the information regarding the link part, and
stopping the operation of the charging robot, based on a comparison between the second torque and a maximum torque value allowed to the link part.

16. The charging robot control apparatus of claim 8, wherein the operations comprise:
outputting a notification that the operation of the charging robot has stopped, based on the operation of the charging robot being stopped, through the inspection of the safety function,
providing information regarding the inspection of the safety function,
determining whether a cause in which the operation is stopped has resolved, after a time point when the information regarding the inspection of the safety function of the charging robot being provided, and
controlling the charging robot to charge the vehicle again, based on the cause in which the operation has stopped is resolved.

17. The charging robot control apparatus of claim 8, wherein the operations comprise:
identifying an obstacle interfering with a charging operation of the charging robot, in the operation area, and
outputting a notification that the obstacle is identified and stopping the operation of the charging robot, based on the obstacle being identified in the operation area.

18. The charging robot control apparatus of claim 17, wherein the operations comprise:
obtaining signals for detecting an object located in the operation area every predetermined time interval, from one or more sensors included in the charging robot, and
determining that the obstacle is present in the operation area, based on at least one of the signals.

19. The charging robot control apparatus of claim 1, wherein the operations comprise:
controlling the charging robot to disconnect a charging cable from the vehicle, based on a battery amount charged in the vehicle being identical to a target battery amount of the vehicle or a difference between the battery amount charged in the vehicle and the target battery amount of the vehicle being within a predetermined range, and
transmitting a notification that the charging is completed to at least one of the vehicle or a portable terminal of a user of the vehicle, based on the charging cable being disconnected from the vehicle.

20. A charging robot control method, comprising:
identifying, based on a number associated with a vehicle being recognized, at least one of a vehicle type of a vehicle or a vehicle information number (VIN) of the vehicle;
controlling, based on a parking state of the vehicle being a parking completion state and a charging request being received from the vehicle, a charging robot to charge the vehicle; and
controlling, based on a target battery amount of the vehicle, the charging robot to stop charging the vehicle.
